(19) United States
(12) Patent Application Publication
(10) Pub. No.: US 2023/0049871 A1
(43) Pub. Date: Feb. 16, 2023

(54) EVENT ANALYSIS SUPPORT APPARATUS, EVENT ANALYSIS SUPPORT METHOD, AND COMPUTER-READABLE RECORDING MEDIUM

(71) Applicant: NEC Corporation, Minato-ku, Tokyo (JP)

(72) Inventor: Shohei MITANI, Tokyo (JP)

(73) Assignee: NEC Corporation, Minato-ku, Tokyo (JP)

(21) Appl. No.: 17/792,881

(22) PCT Filed: Jan. 28, 2020
(86) PCT No.: PCT/JP2020/002951

§ 371 Date: Jul. 14, 2022

(51) Int. Cl. G06F 11/34

(52) U.S. Cl. CPC G06F 11/34; G06F 2201/86

(57) ABSTRACT

An event analysis support apparatus 1 includes: a belonging degree output unit 2 configured to output a belonging degree indicating a degree to which event information pertaining to an event occurring in a system belongs to each of a plurality of event types set in advance, a feature candidate information output unit 3 configured to output feature candidate information for each of the event types, using event information of an event that has newly occurred and feature information expressing a feature among events already generated for each of the event types; and a feature information output unit 4 configured to output new feature information for each of the event types using the feature information, the feature candidate information, and the belonging degree.

### TECHNICAL FIELD

The invention relates to an event analysis support apparatus and an event analysis support method for analyzing an event, and furthermore relates to a computer-readable recording medium having recorded thereon a program for realizing the same.

### BACKGROUND ART

Techniques have been disclosed in which, to prevent attacks on control systems used in infrastructure, plants, buildings, and the like, packets flowing through control system networks (e.g., packets containing control commands, process values, control values, and the like) are monitored and unauthorized control procedures are detected.

As a related technique, Patent Document 1 discloses an event analysis system that inputs events occurring in a monitored system into a prediction model and analyzes events corresponding to the occurrence of anomalies in the monitored system. According to the analysis system of Patent Document 1, the system predicts an event series, detects events that occurred contrary to the prediction, and traces the event series including the detected events back to an anomalous event.

### LIST OF RELATED ART DOCUMENTS

### Patent Document

Patent Document 1: Japanese Patent No. 6280826

### SUMMARY OF INVENTION

### Technical Problems

However, the event analysis system of Patent Document 1 does not assume that noise events flow in the network of a control system, and thus cannot detect anomalous events in a control system in which noise events are mixed.

An example object of the invention is to provide an event analysis support apparatus, an event analysis support method, and a computer-readable recording medium that analyze events accurately even when noise events are mixed in an event series.

### Solution to the Problems

In order to achieve the example object described above, an event analysis support apparatus according to an example aspect of the invention includes:

a belonging degree output unit configured to output a belonging degree indicating a degree to which event information pertaining to an event occurring in a system belongs to each of a plurality of event types set in advance;

a feature candidate information output unit configured to output feature candidate information for each of the event types, using event information of an event that has newly occurred and feature information expressing a feature among events already generated for each of the event types; and

a feature information output unit configured to output new feature information for each of the event types using the feature information, the feature candidate information, and the belonging degree.

Also, in order to achieve the example object described above, an event analysis support method according to an example aspect of the invention includes:

a belonging degree output step of outputting a belonging degree indicating a degree to which event information pertaining to an event occurring in a system belongs to each of a plurality of event types set in advance;

a feature candidate information output step of outputting feature candidate information for each of the event types, using event information of an event that has newly occurred and feature information expressing a feature among events already generated for each of the event types; and

a feature information output step of outputting new feature information for each of the event types using the feature information, the feature candidate information, and the belonging degree.

Furthermore, in order to achieve the example object described above, a computer-readable recording medium according to an example aspect of the invention includes a program recorded on the computer-readable recording medium, the program including instructions that cause the computer to carry out:

a belonging degree output step of outputting a belonging degree indicating a degree to which event information pertaining to an event occurring in a system belongs to each of a plurality of event types set in advance;

a feature candidate information output step of outputting feature candidate information for each of the event types, using event information of an event that has newly occurred and feature information expressing a feature among events already generated for each of the event types; and

a feature information output step of outputting new feature information for each of the event types using the feature information, the feature candidate information, and the belonging degree.

### Advantageous Effects of the Invention

As described above, according to the invention, it is possible to analyze events accurately even when noise events are mixed in a target event series in a system.

### BRIEF DESCRIPTION OF THE DRAWINGS

FIG. 1 is a diagram illustrating an example of the event analysis support apparatus.

FIG. 2 is a diagram illustrating an example of operations of the event analysis support apparatus.

FIG. 3 is a diagram illustrating an example of training by the event analysis support apparatus.

FIG. 4 is a diagram illustrating an example of a drainage control system.

FIG. 5 is a diagram illustrating an example of events in the drainage control system.

FIG. 6 is a diagram illustrating an example of an event series.

FIG. 7 is a diagram illustrating an example of the feature candidate information.

FIG. 8 is a diagram illustrating an example of the feature information.

FIG. 9 is a diagram illustrating an example of operations of the event analysis support apparatus during operations.

FIG. 10 is a diagram illustrating an example of operations of the event analysis support apparatus during training.

FIG. 11 is a block diagram illustrating an example of a computer that realizes the event analysis support apparatus.

### EXAMPLE EMBODIMENT

Example embodiments of the invention will be described hereinafter with reference to the drawings. In the drawings described below, elements having identical or corresponding functions will be assigned the same reference signs, and redundant descriptions thereof may be omitted.

Apparatus Configuration

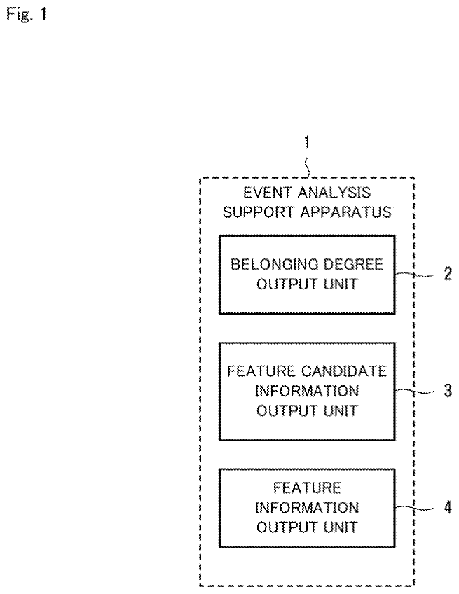

First, the configuration of an event analysis support apparatus 1 according to the example embodiment will be described with reference to FIG. 1. FIG. 1 is a diagram illustrating an example of the event analysis support apparatus. The event analysis support apparatus 1 illustrated in FIG. 1 is an apparatus that can analyze events accurately even when noise events are mixed in a target event series in a system.

The system is a control system used, for example, for public or utility equipment, facilities, structures, or the like, such as power plants, power grids, communication networks, roads, railroads, ports, airports, water and sewage systems, irrigation facilities, and flood control facilities.

“Event series” refers to a series of events that occur when the system is caused to control a target. In other words, “event series” refers to a sequence of events that occur when the target is controlled. The “events” are, for example, various events such as control commands, state transition events, and notification events, as well as process values, control values, and the like, which are used to control the system.

A “noise event” is, for example, an event that is different from the events in the target event series. When the target event series is A→B→A→C, events X and Y, which are different from the events in the target event series, may be mixed in the target event series. For example, noise events are mixed in the target event series, such as A→X→X→Y→X→B→ . . . and so on. Therefore, the target event series cannot be analyzed accurately due to the influence of noise events. In particular, it is even more difficult to analyze the target event series accurately when it is unknown which events are target events and which events are noise events.

Accordingly, in the example embodiment, using the event analysis support apparatus 1 makes it possible to analyze events accurately even if noise events X and Y are mixed in the target event series A→B→A→C.

Next, the event analysis support apparatus 1 illustrated in FIG. 1 includes a belonging degree output unit 2, a feature candidate information output unit 3, and a feature information output unit 4.

Of these, the belonging degree output unit 2 outputs a belonging degree to which event information pertaining to an event occurring in the system belongs to each of a plurality of event types set in advance. The number of types of events need not match the number of event types set. The number of event types is set to be less than or equal to a number of patterns of actual events.

The event information is, for example, identification information that identifies various events, state information that expresses a state of the system, interval information that expresses a time interval between one event and another event, or a combination of two or more of the identification information, the state information, and the interval information.

The event type is information for classifying event information. The event type is information for classifying, for example, the above-described control commands, state transition events, notification events, state information (process values) expressing a state of the system, interval information expressing a time interval between one event and another other event, control values used to control the system, and the like.

For example, if there are k event types set in advance, the belonging degree is information indicating a degree to which the event information belongs to each of the k event types. Specifically, if the number of event types is k=3, the belonging degree is expressed as b=(b1, b2, b3). Each of the elements b1, b2, and b3 of the belonging degree b can be expressed, for example, as a numerical value.

The feature candidate information output unit 3 outputs feature candidate information (latent feature candidates) for each event type using the event information of an event that has newly occurred and feature information (latent features) that has already been generated for each event type and that expresses features among events. The feature candidate information output unit 3 generates the feature candidate information expressing unknown relationships between events for each event type.

The feature information and the feature candidate information are information expressing features such as a sequence between events, a time interval between events, a history of the state of the system, and the like.

The feature information output unit 4 outputs new feature information for each event type using the feature information, the feature candidate information, and the belonging degree. Specifically, it is conceivable for the feature information output unit 4 to update the feature information for each event type by weighting the feature information already generated and the feature candidate information newly generated using the belonging degree of the event that has occurred

For example, assume the number of event types is set to k=3, the belonging degree is b=(b1, b2, b3)=(0.8, 0.1, 0.1), the feature information already generated is Fi=(Fi1, Fi, Fi3), and the feature candidate information Fc=(Fc1, Fc2, Fc3).

Furthermore, assume that each element of the feature information Fi is represented by Fi1=(1, 1, 1, 1), Fi2=(2, 2, 2, 2), and Fi3=(3, 3, 3, 3), and that each element of the feature candidate information Fc generated by the feature candidate information output unit 3 is Fc1=(1, 2, 3, 4), Fc2=(5, 6, 7, 8), and Fc3=(−1, −2, −3, −4).

In such a case, each element of the new feature information Fi=(Fi1, Fi2, Fi3) for each event type is obtained by weighting the feature information Fi and the feature candidate information Fc using the belonging degree b and adding the weighted feature information Fi and the feature candidate information Fc, as indicated by Formula 1.

$$\begin{matrix}Fi 1 = ( 1 - b 1 ) Fi 1 + b 1 \times Fc 1 \\ Fi 1 = 0.2 \times ( 1 , 1 , 1 , 1 ) + 0.8 \times ( 1 , 2 , 3 , 4 ) \\ = ( 1. , 1.8 , 2.6 , 3.4 )\end{matrix} \qquad Formula 1$$

$$\begin{matrix}Fi 2 = ( 1 - b 2 ) Fi 2 + b 2 \times Fc 2 \\ Fi 2 = 0.9 \times ( 2 , 2 , 2 , 2 ) + 0.1 * ( 5 , 6 , 7 , 8 ) \\ = ( 2.3 , 2.4 , 2.5 , 2.6 )\end{matrix}$$

$$\begin{matrix}Fi 3 = ( 1 - b 3 ) Fi 3 + b 3 * Fc 3 \\ Fi 3 = 0.9 * ( 3 , 3 , 3 , 3 ) + 0.1 * ( - 1 , - 2 , - 3 , - 4 ) \\ = ( 2.6 , 2.5 , 2.4 , 2.3 )\end{matrix}$$

Note that when using the model indicated in Formula 1, the feature information Fi corresponding to the event type for which the element of the belonging degree b is 0 does not depend on the feature candidate information because the weight is 0. Therefore, it is sufficient for the feature candidate information output unit 3 to output only the feature candidate information corresponding to event types for which the belonging degree b is at least non-zero.

The generation of the feature information is not limited to the model indicated by Formula 1. For example, the feature information Fi, the feature candidate information Fc, and the belonging degree b may be input into a model generated through machine learning, and new feature information Fi may be generated.

In this manner, in the present example embodiment, the feature information for each event type is updated using the belonging degree of the event, the feature information already generated, and the feature candidate information newly generated. In particular, by using a model (e.g., Formula 1) in which the magnitude relationship of belonging degrees and the magnitude relationship of contributions (weights) of the feature candidate information to the new feature information match, even if noise events are mixed in the event series, the contribution of the candidate feature information generated when a noise event occurs can be suppressed and the influence of the noise event on the feature information can be reduced. Various event analyses can also be performed accurately by using this feature information.

System Configuration

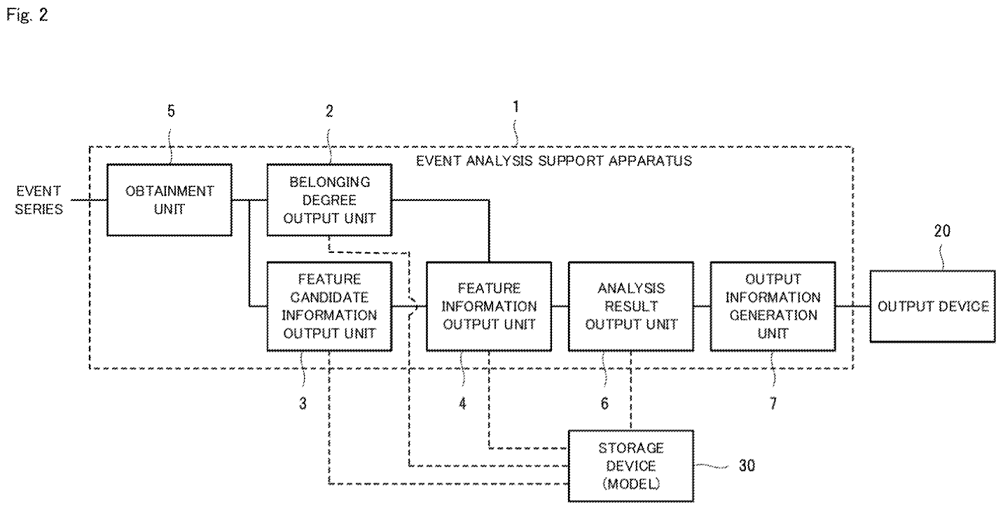

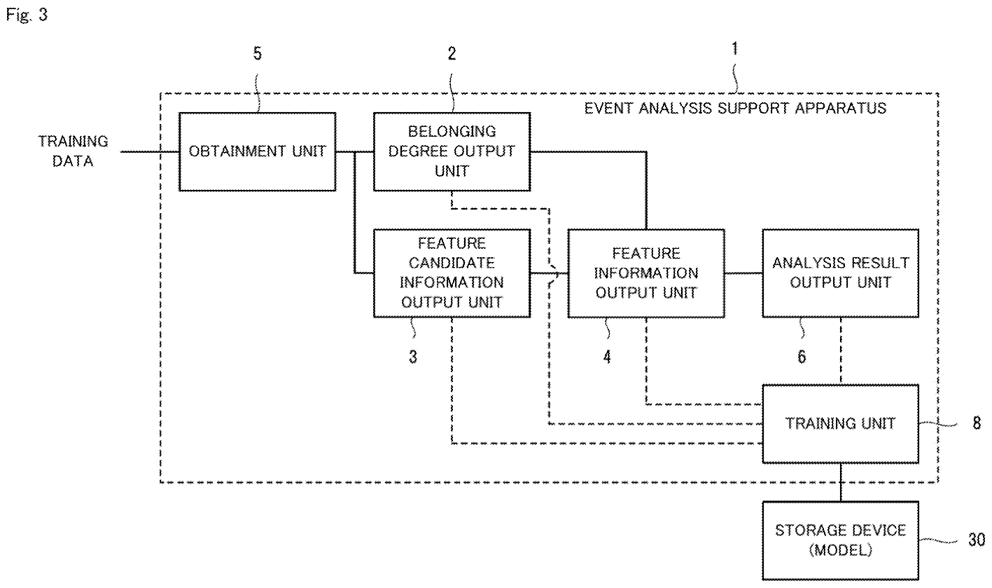

Next, the configuration of the event analysis support apparatus 1 according to the example embodiment will be described in further detail with reference to FIGS. 2 and 3. FIG. 2 is a diagram illustrating an example of operations of the event analysis support apparatus. FIG. 3 is a diagram illustrating an example of training by the event analysis support apparatus.

As illustrated in FIG. 2, the event analysis support apparatus 1 in the present example embodiment uses the belonging degree output unit 2, the feature candidate information output unit 3, the feature information output unit 4, an obtainment unit 5, and an analysis result output unit 6 during operations. In addition, during operations, when displaying an analysis result, an output information generation unit 7 is furthermore used. In addition, during training, the event analysis support apparatus 1 furthermore uses a training unit 8 to train each of the models used by the belonging degree output unit 2, the feature candidate information output unit 3, the feature information output unit 4, and the analysis result output unit 6.

Operations will be described here.

During operations, the obtainment unit 5 obtains an event occurring in the target system. Specifically, first, the obtainment unit 5 obtains packets flowing in a network of the system, log files, or both. The obtainment unit 5 then detects an event using the packets, the log files, or both. The obtainment unit 5 then outputs the detected event to the belonging degree output unit 2 and the feature candidate information output unit 3.

During operations, the belonging degree output unit 2 outputs the belonging degree, which expresses the degree to which an event occurring in the target system belongs to each of the plurality of event types set in advance. The number of types of events need not match the number of event types set. The number of event types is set to be less than or equal to a number of patterns of actual events.

Specifically, the belonging degree output unit 2 first obtains an event from the obtainment unit 5. The belonging degree output unit 2 then inputs the event obtained into a belonging degree output model. The belonging degree output unit 2 then outputs the belonging degree output from the belonging degree output model to the feature information output unit 4.

The belonging degree output model may be, for example, a linear model, a logistic model, a support vector machine, a parametric probability model, a nonparametric probability model, a Bayesian model, a Gaussian process, a tree structure model, a rule-based model, or the like, as well as a neural network-based model.

The belonging degree output model is stored in a storage device 30 provided outside the event analysis support apparatus 1, as illustrated in FIG. 2. However, the storage device 30 may be provided within the event analysis support apparatus 1. The training of the belonging degree output model will be described later. The storage device 30 is a storage device such as a server computer or a database, for example.

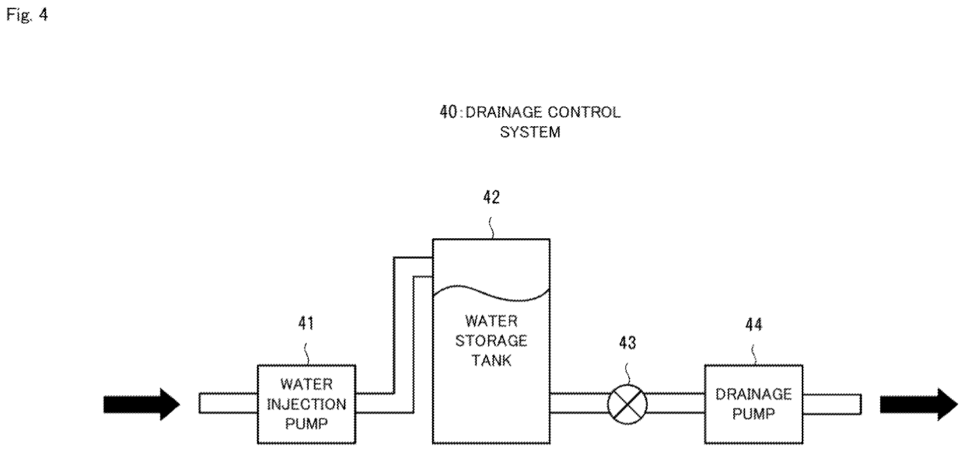

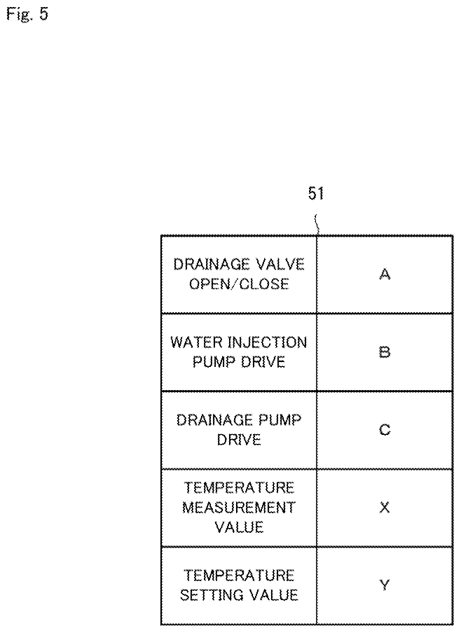

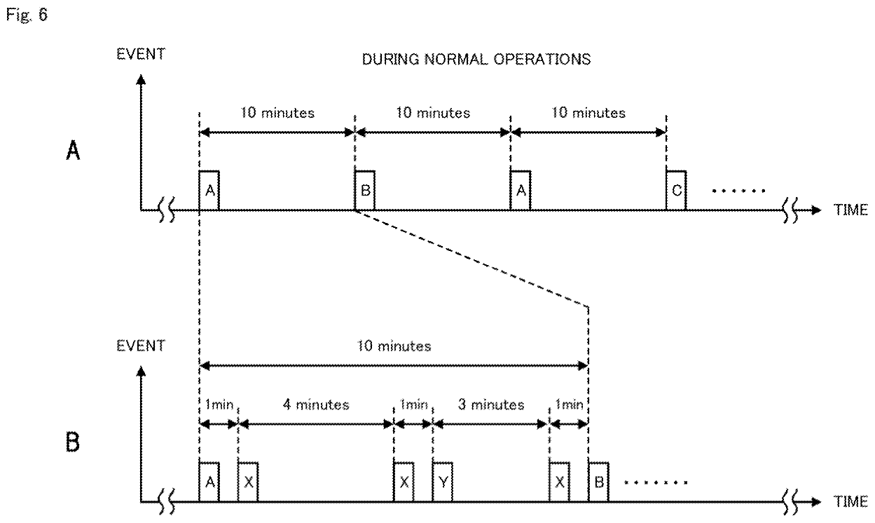

The belonging degree will be described in detail with reference to FIGS. 4, 5, and 6. FIG. 4 is a diagram illustrating an example of a drainage control system. FIG. 5 is a diagram illustrating an example of events in the drainage control system. FIG. 6 is a diagram illustrating an example of an event series.

A drainage control system 40 illustrated in FIG. 4 is a drainage control system that uses a water injection pump 41, a water storage tank 42, a drainage valve 43, a drainage pump 44, and the like to store incoming water in a storage tank and then drain the water. During normal operations, packets corresponding to the events illustrated in FIG. 5 flow through a network provided in the drainage control system 40.

In the drainage control system 40 illustrated in FIG. 4, during normal operations, a packet having a control command for closing the drainage valve 43 to prepare for water injection (drainage valve open/close (A) in FIG. 5) first flows in the network, as illustrated in FIG. 6. Next, after about 10 minutes, a packet having a control command for driving the water injection pump 41 to inject a default amount of water into the water storage tank 42 (water injection pump drive (B) in FIG. 5) flows in the network. Next, after about 10 minutes, a packet having a control command for opening the drainage valve 43 for drainage (drainage valve open/close (A) in FIG. 5) flows in the network. Next, after about 10 minutes, a packet having a control command for driving the drainage pump 44 to drain the water (drainage pump drive (C) in FIG. 5) flows in the network.

Therefore, the event series when performing drainage control is A→B→A→C, as illustrated in FIG. 6A. In reality, however, noise events such as events X (temperature measurement value in FIG. 5), Y (temperature setting value in FIG. 5), and the like are mixed into the event series, resulting in A→X→X→Y→X→B→ . . . or the like, as illustrated in FIG. 6B.

Next, in the drainage control system 40 described above, if the number of event types is set to k=5 in advance, the belonging degree output unit 2 outputs a belonging degree b=(b1, b2, b3, b4, b5) as the belonging degree. If the belonging degree output model is a model that outputs a belonging degree of belonging to event types b1, b2, b3, b4, and b5, then upon obtaining event A, the belonging degree output unit 2 outputs a belonging degree b=(1, 0, 0, 0, 0). When the noise event X is obtained, the belonging degree output unit 2 outputs a belonging degree b=(0, 0, 0, 1, 0).

Immediately after obtaining the event A described above, the feature candidate information output unit 3 and the feature information output unit 4 update the feature information. Assume that as a result, Fi=(Fi1, Fi2, Fi3, Fi4, Fi5) is output as the feature information.

Then, immediately after obtaining the noise event X, the feature candidate information output unit 3 outputs Fc=(Fc1, Fc2, Fc3, Fc4, Fc5) as the feature candidate information. However, because the belonging degree b=(0, 0, 0, 1, 0), the feature information output unit 4 outputs Fi′=(Fi1, Fi2, Fi3, Fc4, Fi5) as the feature information. In other words, upon receiving the noise event X, only the fourth feature information Fi4 is updated and changed to Fc4, and the other feature information is not changed.

In this manner, there are only two pieces of feature information, namely Fi4 and Fi5, in the feature information Fi that change in response to the noise events X and Y being received. On the other hand, the three pieces of feature information Fi1, Fi2, and Fi3 are held without being affected by the noise events. Therefore, even if many noise events are mixed in an event series, the feature information Fi1, Fi2, and Fi3 are not disturbed by the noise events, which enables highly-accurate analysis.

When the event Y is then obtained, the belonging degree output unit 2 outputs a belonging degree b=(0, 0, 0, 0, 1). When the event B is then obtained, the belonging degree output unit 2 outputs a belonging degree b=(0, 1, 0, 0, 0). Therefore, the first, second, and third feature information Fi1, Fi2, and Fi3 are not changed at all by the noise events X and Y at the point in time when up to A→X→X→Y→X, among the event series A→X→X→Y→X→B→ . . . in which the noise events are mixed, is received.

Then, the next time the event B is received, the feature candidate information output unit 3 and the feature information output unit 4 update only the second feature information Fi2, based on the feature information Fi=(Fi1, Fi2, Fi3, Fi4, Fi5). This allows the feature information Fi1 updated when the event A is obtained to be carried over to the feature information Fi2 updated when the event B is obtained, without being disturbed by noise events. Therefore, the feature information updated when the event B is obtained is compressed information expressing the feature information updated when the event A is obtained, the sequential relationship that the event B was obtained after the event A, the time interval between the event A and the event B, and state information such as pressure, temperature, and a system state associated with event B.

Therefore, by repeating the feature information update described above, even when it is not known which events are target events and which events are noise events, it is possible to extract useful features such as the sequential relationship of an event series with regularity, without being disturbed by noise events.

Furthermore, although the number of event types is k=5 and the number of event patterns (A, B, C, X, Y)) is also 5 in the example described above, which produces the results described above, the number of event types and the number of event patterns need not be the same. The computational amount of the belonging degree output unit 2, the feature candidate information output unit 3, and the feature information output unit 4 is proportional to the number of event types, and thus the computational amount can be suppressed by having the number of event types be smaller than the actual number of event patterns.

Specifically, although in the belonging degree output model described above, the belonging degree for each event type is expressed using binary values of “1” and “0”, the belonging degree may be expressed using numerical values between 0 and 1.

For example, if the number of event types is different from the number of event patterns, such as the number of event types being k=4 and the number of event patterns (A, B, C, X, Y) being 5, the belonging degree output model may be a model which outputs a belonging degree b=(0.9, 0.05, 0.02, 0.03) when the event A is obtained and a belonging degree b=(0.05, 0.05, 0.02, 0.88) when the event X is obtained.

Assume that Fi=(Fi1, Fi2, Fi3, Fi4, Fi5) is output as the feature information as a result of the feature candidate information output unit 3 and the feature information output unit 4 updating the feature information immediately after obtaining the event A described above.

Then, immediately after obtaining the noise event X, the feature candidate information output unit 3 outputs Fc=(Fc1, Fc2, Fc3, Fc4) as the feature candidate information, but because the belonging degree b=(0.05, 0.05, 0.02, 0.88), the feature information output unit 4 outputs Fi′=(0.95×Fi1+0.05×Fc1, 0.95×Fi2+0.05×Fc2, 0.98×Fi3+0.02×Fc3, 0.12×Fi4+0.88×Fc4) as the feature information.

In other words, as a result of the noise event X being received, the fourth feature information Fi4 loses 88% and changes to 0.12×Fi4+0.88×Fc4, but only 2% to 5% of the other feature information is lost, with 95% to 98% being held.

In this manner, the event types having feature information which changes in response to the noise events X and Y being received are suppressed to about one or two out of four, and the remaining feature information enables highly accurate analysis by holding features that are not disturbed by noise events.

Note that in the training of the belonging degree output model, supervisory data indicating which event type input training event data belongs to is not required.

The feature candidate information output unit 3 outputs feature candidate information for each event type at the time of operation, using the event information of an event newly generated and the feature information expressing features among events already generated for each event type.

Specifically, the feature candidate information output unit 3 first obtains an event from the obtainment unit 5. The feature candidate information output unit 3 then inputs the event obtained and feature information for each current event type into a feature candidate information output model. The feature candidate information output unit 3 then outputs the feature candidate information for each event type output from the feature candidate information output model to the feature information output unit 4.

The feature candidate information output model may, for example, use a neural network, LSTM (Long Short Term Memory), Attention-RNN (Recurrent Neural Network), or Transformer. The feature candidate information output model is stored in the storage device 30.

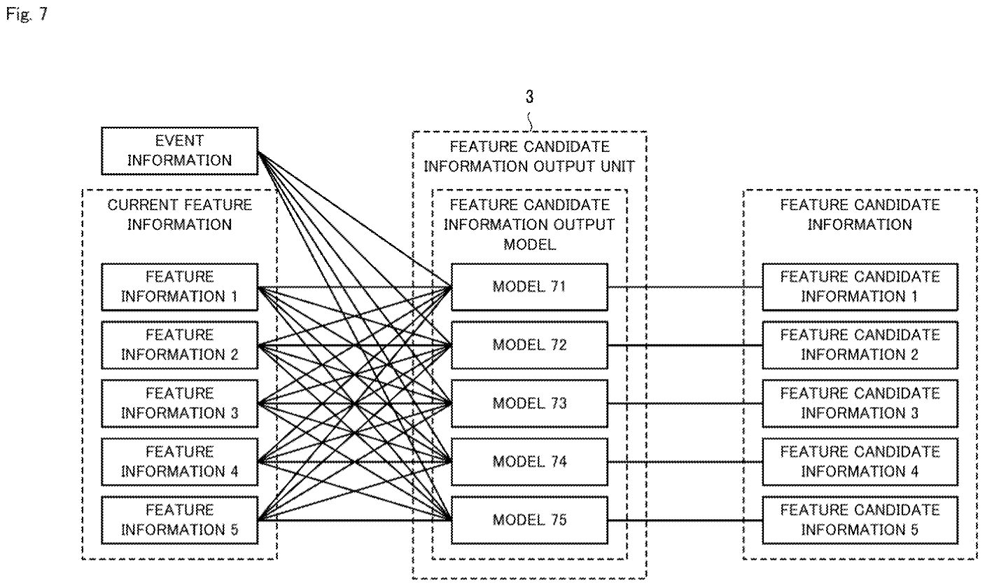

FIG. 7 is a diagram illustrating an example of the feature candidate information. FIG. 7 illustrates an example when the number of event types is k=5. In this case, first, the event information obtained and feature information 1, 2, 3, 4, and 5 for each current event type are input into models 1, 2, 3, 4, and 5 of the feature candidate information output model, respectively. Upon doing so, the models 71, 72, 73, 74, and 75 output feature candidate information 1, 2, 3, 4, and 5, respectively. Although models 71 through 75 are used in FIG. 7 for ease of description, the number of models is not limited to five.

During operations, the feature information output unit 4 outputs new feature information for each event type using the feature information, the feature candidate information, and the belonging degree.

Specifically, the feature information output unit 4 first obtains the belonging degree from the belonging degree output unit 2. The feature information output unit 4 obtains the feature candidate information for each event type from the feature candidate information output unit 3. The feature information output unit 4 then inputs the feature information, the feature candidate information, and the belonging degree for each current event type into a feature information output model. The feature information output unit 4 then outputs the feature information for each event type, output from the feature information output model, to the analysis result output unit 6.

The feature information output model may, for example, calculate weighted sums of feature candidate information and the feature information resulting from the belonging degree, as indicated by Formula 1 above, or may perform nonlinear transformations using a neural network or the like. The feature information output model is stored in the storage device 30.

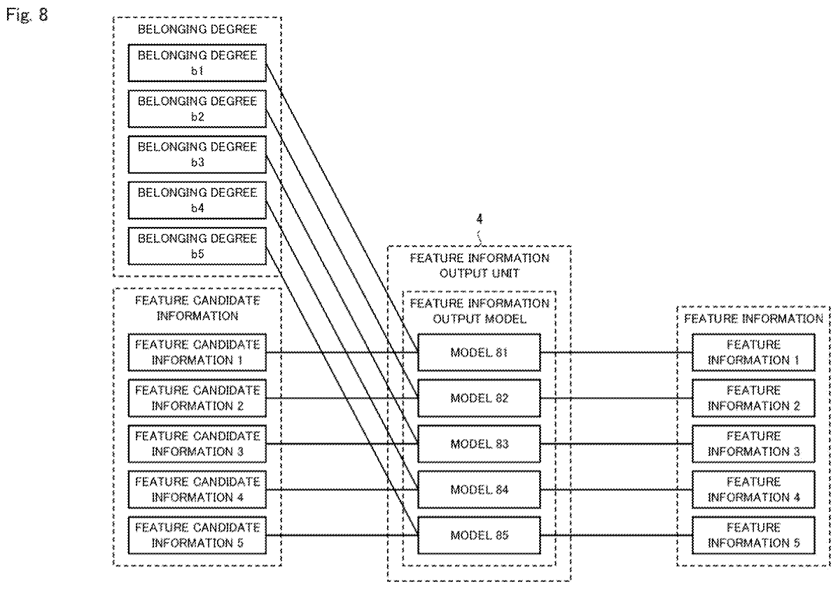

FIG. 8 is a diagram illustrating an example of the feature information. FIG. 8 illustrates an example when the number of event types is k=5. In this case, first, the belonging degrees b1, b2, b3, b4, b5 and the feature candidate information 1, 2, 3, 4, 5 for each event type are input into the feature information output model. In the example in FIG. 8, a model 81 outputs new feature information 1 using the belonging degree b1 and feature candidate information 1. For each of models 82, 83, 84, and 85, new feature information 2, 3, 4, and 5 is also output using the belonging degree and feature candidate information corresponding to the model. Although models 81 through 85 are used in FIG. 8 for ease of description, the number of models is not limited to five.

The analysis result output unit 6 inputs feature information for each event type into an analysis model set in advance, and outputs an analysis result. Specifically, the analysis result output unit 6 first obtains the feature information from the feature information output unit 4. The analysis result output unit 6 then inputs the feature information for each event type into the analysis model. The analysis result output unit 6 then outputs analysis result information, representing the analysis result output from the analysis model, to the output information generation unit 7.

For example, a system becomes anomalous when a control procedure is anomalous, and thus the feature information for each event type is input to the analysis result output unit 6 to detect an anomalous event series. Because the state of the system and events become inconsistent when inappropriate control is applied with respect to the state of the system, the feature information for each event type is input to the analysis result output unit 6 and inconsistencies between the state of the system and events are detected.

The analysis model is a model that inputs feature information for each event type into a neural network or the like and outputs a desired result. The analysis model may, for example, predict event series, classify events, detect anomalies in target event series, and the like. Anomaly detection is performed using, for example, an analysis model with one-class learning (one-class SVM, one-class SVDD, or the like) using feature information, or an analysis model trained without supervision (self-organizing maps, principal component analysis, metric learning, Auto Encoder, or the like).

The output information generation unit 7 obtains the analysis result information from the analysis result output unit 6, converts the analysis result information obtained into output information that can be output to an output device 20, and transmits the output information to the output device 20.

The output device 20 obtains output information, which has been converted into an output-ready format by the output information generation unit 7, and outputs a generated image, audio, and the like on the basis of the output information. The output device 20 is, for example, an image display device or the like that uses liquid crystals, organic EL (Electro Luminescence), or a CRT (Cathode Ray Tube). Furthermore, the image display device may include an audio output device such as a speaker or the like. The output device 20 may be a printing device such as a printer or the like.

Next, the training will be described.

The training unit 8 trains the belonging degree output unit 2, the feature candidate information output unit 3, the feature information output unit 4, and the analysis result output unit 6 using event series that have occurred in the system in the past. Specifically, first, an event series that has occurred in the past (e.g., training data such as an event series obtained during normal operations) is input to the event analysis support apparatus 1. The training unit 8 then obtains the information output from the belonging degree output unit 2, the feature candidate information output unit 3, the feature information output unit 4, and the analysis result output unit 6, respectively. The training unit 8 then uses the output information to train the belonging degree output model, the feature candidate information output model, the feature information output model, and the analysis model.

If the belonging degree output model, the feature candidate output model, the feature information output model, and the analysis model are all machine learning models having objective functions and training parameters, such as neural networks, the training unit 8 optimizes the value of the objective function calculated by the final output of the analysis model output by adjusting the training parameters of the machine learning model.

If the analysis model is for simple prediction, classification, or anomaly detection, the objective function can be a mean square error function, cross-entropy function, hinge loss function, log likelihood function, log posterior probability function, entropy function, Gini coefficient, or the like.

In addition, gradient descent, conjugate gradient, coordinate descent, Newton's method, variational Bayes with sampling, dynamic programming, greedy methods, and the like can be used to adjust the training parameters.

Apparatus Operations

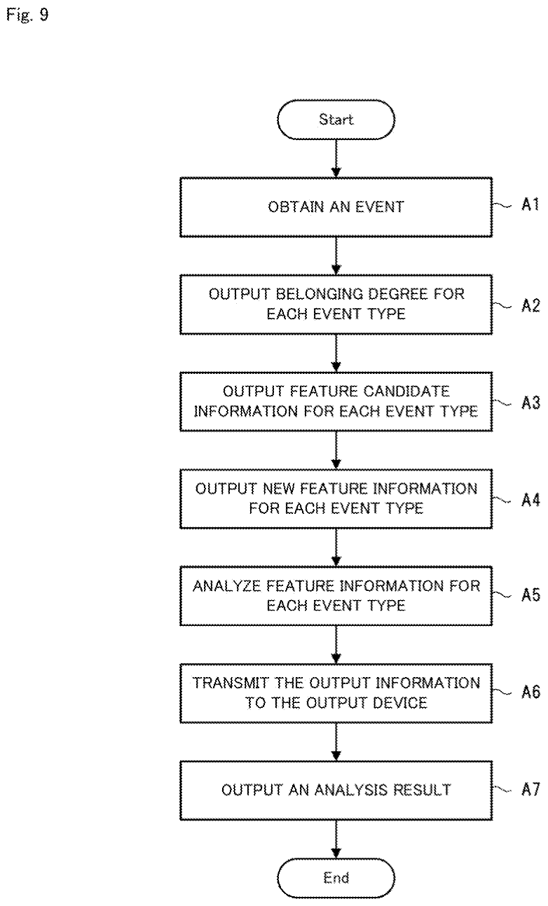

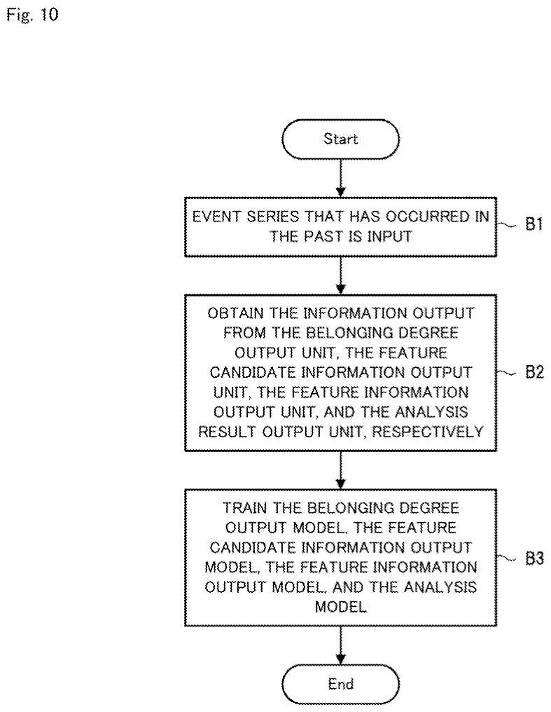

Next, operations of the event analysis support apparatus according to an example embodiment of the invention will be described with reference to FIGS. 9 and 10. FIG. 9 is a diagram illustrating an example of operations of the event analysis support apparatus during operations. FIG. 10 is a diagram illustrating an example of operations of the event analysis support apparatus during training. The following descriptions will refer to FIGS. 1 to 8 as appropriate. In addition, in the example embodiment, an event analysis support method is realized by causing the event analysis support apparatus to operate. As such, the following descriptions of the operations of the event analysis support apparatus will be given in place of descriptions of the event analysis support method according to the example embodiment.

Operations performed during the operation will be described with reference to FIG. 9.

As illustrated in FIG. 9, first, during operations, the obtainment unit 5 obtains an event occurring in the target system (step A1). Specifically, first, in step A1, the obtainment unit 5 obtains packets flowing in a network of the system, log files, or both. Then, in step A1, the obtainment unit 5 detects an event using the packets, the log files, or both. Then, in step A1, the obtainment unit 5 outputs the detected event to the belonging degree output unit 2 and the feature candidate information output unit 3.

Next, during operations, the belonging degree output unit 2 outputs the belonging degree, which expresses the degree to which event information pertaining to an event occurring in the target system belongs to each of the plurality of event types set in advance (step A2). Note that the number of event types is set to be less than or equal to a number of patterns of actual events.

Specifically, in step A2, the belonging degree output unit 2 first obtains an event from the obtainment unit 5. Then, in step A2, the belonging degree output unit 2 inputs the event obtained into a belonging degree output model. Then, in step A2, the belonging degree output unit 2 outputs the belonging degree output from the belonging degree output model to the feature information output unit 4.

Next, the feature candidate information output unit 3 outputs feature candidate information for each event type at the time of operation, using the event information of an event newly generated and the feature information expressing features among events already generated for each event type (step A3).

Specifically, in step A3, the feature candidate information output unit 3 first obtains an event from the obtainment unit 5. Then, in step A3, the feature candidate information output unit 3 inputs the event obtained and feature information for each current event type into a feature candidate information output model. Then, in step A3, the feature candidate information output unit 3 outputs the feature candidate information for each event type output from the feature candidate information output model to the feature information output unit 4.

Next, during operations, the feature information output unit 4 outputs new feature information for each event type using the feature information, the feature candidate information, and the belonging degree (step A4).

Specifically, in step A4, the feature information output unit 4 first obtains the belonging degree from the belonging degree output unit 2. Additionally, in step A4, the feature information output unit 4 obtains the feature candidate information for each event type from the feature candidate information output unit 3. Then, in step A4, the feature information output unit 4 inputs the feature information, the feature candidate information, and the belonging degree for each current event type into a feature information output model. Then, in step A4, the feature information output unit 4 outputs the feature information for each event type, output from the feature information output model, to the analysis result output unit 6.

Next, the analysis result output unit 6 inputs feature information for each event type into an analysis model set in advance, and outputs an analysis result (step A5).

Specifically, in step A5, the analysis result output unit 6 first obtains the feature information from the feature information output unit 4. Then, in step A5, the analysis result output unit 6 inputs the feature information for each event type into the analysis model. Then, in step A5, the analysis result output unit 6 outputs analysis result information, representing the analysis result output from the analysis model, to the output information generation unit 7.

Next, the output information generation unit 7 obtains the analysis result information from the analysis result output unit 6, converts the analysis result information obtained into output information that can be output to the output device 20, and transmits the output information to the output device 20 (step A6). Next, the output device 20 obtains output information, which has been converted into an output-ready format by the output information generation unit 7, and outputs a generated image, audio, and the like on the basis of the output information (step A7).

The event analysis support apparatus 1 repeats steps A1 to A7 each time an event occurs. Note that steps A1 to A4 are executed each time an event occurs, and step A5 to step A7 are executed at timings set in advance.

Operations performed during training will be described with reference to FIG. 10.

As illustrated in FIG. 10, first, an event series that has occurred in the past (e.g., training data such as an event series obtained during normal operations) is input to the event analysis support apparatus 1 (step B1).

The training unit 8 then obtains the information output from the belonging degree output unit 2, the feature candidate information output unit 3, the feature information output unit 4, and the analysis result output unit 6, respectively (step B2).

The training unit 8 then uses the output information to train the belonging degree output model, the feature candidate information output model, the feature information output model, and the analysis model (step B3).

Effects of Example Embodiment

As describe thus far, according to the present example embodiment, the feature information for each event type is updated using the belonging degree of the event, the feature information already generated, and the feature candidate information newly generated. Accordingly, the magnitude relationship of belonging degrees and the magnitude relationship of contributions of the feature candidate information to the new feature information are caused to match, and the contribution of feature candidate information generated from noise events is suppressed, and thus even if noise events are mixed in the event series, the influence of the noise event on the feature information can be reduced.

Additionally, various event analyses can be performed accurately by using the feature information generated by the event analysis support apparatus 1.

For example, the accuracy can be improved for analyses such as customer behavior prediction, crime occurrence prediction, solution concentration and equipment condition prediction, prediction of subsequent consumption behavior from the most recent customer purchase order and consumption amount, prediction of subsequent occurrences from the order and frequency of the occurrences of many types of crimes, subsequent operation orders and environmental values from the operation orders and environmental values of many types of equipment, and the like.

The accuracy can also be improved for analyses of unauthorized inputs to a system, anomalous device operations, monitoring of abnormal behavior, and the like. Specifically, the accuracy can be improved for monitoring whether input procedures, operating procedures, and the like are consistent with the environment or whether the resulting equipment behavior is normal.

Furthermore, the accuracy can be improved for analyses such as the classification of diseases and physical conditions, the classification of equipment, and the classification of customer behavior. Specifically, the accuracy can be improved for analysis by classifying a subject's physical condition based on events such as the most recent medical examination history, meals, sleep, and the like, classifying equipment types based on equipment operation logs and communication packet series, classifying customer types based on customer purchase events and transaction event series, and the like.

Even when noise events influence subsequent event series, feature information is used, and thus both events and noise events can be automatically taken into account while distinguishing between the two.

When there are many types of event patterns (e.g., 1000 types) or when the types cannot be defined because the event values are continuous values, these can be compressed into a small number of k event types (e.g., 10 types).

### [Program]

The program according to an embodiment of the invention may be a program that causes a computer to execute steps A1 to A7 shown in FIG. 9, or may be a program that causes a computer to execute steps B1 to B3 shown in FIG. 10. By installing this program in a computer and executing the program, the event analysis support apparatus and the event analysis support method according to the example embodiment can be realized. In this case, the processor of the computer performs processing to function as the obtainment unit 5, the belonging degree output unit 2, the feature candidate information output unit 3, the feature information output unit 4, the analysis result output unit 6, the output information generation unit 7, and the training unit 8.

Also, the program according to the embodiment may be executed by a computer system constructed by a plurality of computers. In this case, for example, each computer may function as any of the obtainment unit 5, the belonging degree output unit 2, the feature candidate information output unit 3, the feature information output unit 4, the analysis result output unit 6, the output information generation unit 7, and the training unit 8.

### [Physical Configuration]

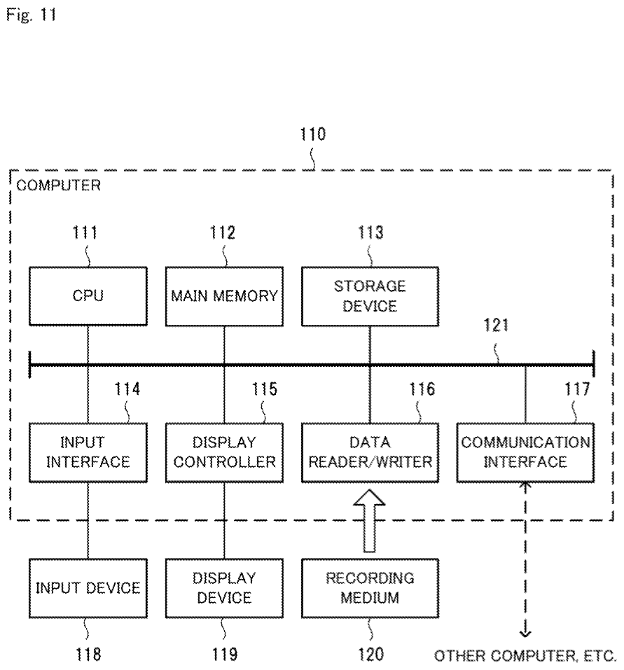

Here, a computer that realizes an event analysis support apparatus by executing the program according to an example embodiment will be described with reference to FIG. 11. FIG. 11 is a block diagram showing an example of a computer that realizes the event analysis support apparatus according to an example embodiment of the invention.

As shown in FIG. 11, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the event analysis support apparatus 1 according to this example embodiment can also be realized by using hardware corresponding to each unit. Furthermore, a portion of the event analysis support apparatus 1 may be realized by a program, and the remaining portion realized by hardware.

### [Supplementary Notes]

Furthermore, the following supplementary notes are disclosed regarding the example embodiments described above. Some portion or all of the example embodiments described above can be realized according to (supplementary note 1) to (supplementary note 18) described below, but the below description does not limit the invention.

### (Supplementary Note 1)

An event analysis support apparatus comprising:

a belonging degree output unit configured to output a belonging degree indicating a degree to which event information pertaining to an event occurring in a system belongs to each of a plurality of event types set in advance;

a feature candidate information output unit configured to output feature candidate information for each of the event types, using event information of an event that has newly occurred and feature information expressing a feature among events already generated for each of the event types; and

a feature information output unit configured to output new feature information for each of the event types using the feature information, the feature candidate information, and the belonging degree.

### (Supplementary Note 2)

The event analysis support apparatus according to supplementary note 1, further comprising:

an analysis result output unit configured to input the feature information into an analysis model set in advance and outputting an analysis result.

### (Supplementary Note 3)

The event analysis support apparatus according to supplementary note 1 or 2,

wherein the event information includes identification information that expresses a type of the event, state information that expresses a state of the system, interval information that expresses a time interval between the event and another event, or information that is a combination of two or more of the identification information, the state information, and the interval information.

### (Supplementary Note 4)

The event analysis support apparatus according to any one of supplementary notes 1 to 3,

wherein a magnitude relationship of the belonging degree and a magnitude relationship of a contribution of the feature candidate information to the new feature information match.

### (Supplementary Note 5)

The event analysis support apparatus according to any one of supplementary notes 1 to 4,

wherein a number of the event types is set to be less than or equal to a number of patterns of actual events.

### (Supplementary Note 6)

The event analysis support apparatus according to any one of supplementary notes 1 to 5, further comprising:

a training unit configured to train models used by the belonging degree output unit, the feature candidate output unit, and the feature information output unit, using an event series that occurred in the system in the past.

### (Supplementary Note 7)

An event analysis support method comprising:

a belonging degree output step of outputting a belonging degree indicating a degree to which event information pertaining to an event occurring in a system belongs to each of a plurality of event types set in advance;

a feature candidate information output step of outputting feature candidate information for each of the event types, using event information of an event that has newly occurred and feature information expressing a feature among events already generated for each of the event types; and

a feature information output step of outputting new feature information for each of the event types using the feature information, the feature candidate information, and the belonging degree.

### (Supplementary Note 8)

The event analysis support method according to supplementary note 7, further comprising:

an analysis result output step of inputting the feature information into an analysis model set in advance and outputting an analysis result.

### (Supplementary Note 9)

The event analysis support method according to supplementary note 7 or 8,

wherein the event information includes identification information that expresses a type of the event, state information that expresses a state of the system, interval information that expresses a time interval between the event and another event, or information that is a combination of two or more of the identification information, the state information, and the interval information.

### (Supplementary Note 10)

The event analysis support method according to any one of supplementary notes 7 to 9,

wherein a magnitude relationship of the belonging degree and a magnitude relationship of a contribution of the feature candidate information to the new feature information match.

### (Supplementary Note 11)

The event analysis support method according to any one of supplementary notes 7 to 10,

wherein a number of the event types is set to be less than or equal to a number of patterns of actual events.

### (Supplementary Note 12)

The event analysis support method according to any one of supplementary notes 7 to 11, further comprising:

a training step of training models output the belonging degree, the feature candidate information, and the feature information, using an event series that occurred in the system in the past.

### (Supplementary Note 13)

A computer-readable recording medium that includes a program recorded thereon, the program including instructions that cause a computer to carry out:

a belonging degree output step of outputting a belonging degree indicating a degree to which event information pertaining to an event occurring in a system belongs to each of a plurality of event types set in advance;

a feature candidate information output step of outputting feature candidate information for each of the event types, using event information of an event that has newly occurred and feature information expressing a feature among events already generated for each of the event types; and

a feature information output step of outputting new feature information for each of the event types using the feature information, the feature candidate information, and the belonging degree.

### (Supplementary Note 14)

The computer-readable recording medium according to supplementary note 13, the program further including instructions that cause the computer to carry out:

an analysis result output step of inputting the feature information into an analysis model set in advance and outputting an analysis result.

### (Supplementary Note 15)

The computer-readable recording medium according to supplementary note 13 or 14,

wherein the event information includes identification information that expresses a type of the event, state information that expresses a state of the system, interval information that expresses a time interval between the event and another event, or information that is a combination of two or more of the identification information, the state information, and the interval information.

### (Supplementary Note 16)

The computer-readable recording medium according to any one of supplementary notes 13 to 15,

wherein a magnitude relationship of the belonging degree and a magnitude relationship of a contribution of the feature candidate information to the new feature information match.

### (Supplementary Note 17)

The computer-readable recording medium according to any one of supplementary notes 13 to 16,

wherein a number of the event types is set to be less than or equal to a number of patterns of actual events.

### (Supplementary Note 18)

The computer-readable recording medium according to any one of supplementary notes 13 to 17, the program further including instructions that cause the computer to carry out:

a training step of training models that output the belonging degree, the feature candidate information, and the feature information, using an event series that occurred in the system in the past.

Although the invention of this application has been described with reference to exemplary embodiments, the invention of this application is not limited to the above exemplary embodiments. Within the scope of the invention of this application, various changes that can be understood by those skilled in the art can be made to the configuration and details of the invention of this application.

### INDUSTRIAL APPLICABILITY

As described above, according to the invention, it is possible to analyze events accurately even when noise events are mixed in a target event series. The invention is useful in fields where it is necessary to analyze events.

### LIST OF REFERENCE SIGNS

1 Event analysis support apparatus
2 Belonging degree output unit
3 Feature candidate information output unit
4 Feature information output unit
5 Obtainment unit
6 Analysis result output unit
7 Output information generation unit
8 Training unit
20 Output device
30 Storage device
40 Drainage control system
41 Water injection pump
42 Water storage tank
43 Drainage valve
44 Drainage pump
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An event analysis support apparatus comprising:
a belonging degree output unit configured to output a belonging degree indicating a degree to which event information pertaining to an event occurring in a system belongs to each of a plurality of event types set in advance;
a feature candidate information output unit configured to output feature candidate information for each of the event types, using event information of an event that has newly occurred and feature information expressing a feature among events already generated for each of the event types; and
a feature information output unit configured to output new feature information for each of the event types using the feature information, the feature candidate information, and the belonging degree.

2. The event analysis support apparatus according to claim 1, further comprising:
an analysis result output unit configured to input the feature information into an analysis model set in advance and outputting an analysis result.

3. The event analysis support apparatus according to claim 1,
wherein the event information includes identification information that expresses a type of the event, state information that expresses a state of the system, interval information that expresses a time interval between the event and another event, or information that is a combination of two or more of the identification information, the state information, and the interval information.

4. The event analysis support apparatus according to claim 1,
wherein a magnitude relationship of the belonging degree and a magnitude relationship of a contribution of the feature candidate information to the new feature information match.

5. The event analysis support apparatus according to claim 1,
wherein a number of the event types is set to be less than or equal to a number of patterns of actual events.

6. The event analysis support apparatus according to claim 1, further comprising:
a training unit configured to train models used by the belonging degree output unit, the feature candidate output information unit, and the feature information output unit, using an event series that occurred in the system in the past.

7. An event analysis support method comprising:
outputting a belonging degree indicating a degree to which event information pertaining to an event occurring in a system belongs to each of a plurality of event types set in advance;
outputting feature candidate information for each of the event types, using event information of an event that has newly occurred and feature information expressing a feature among events already generated for each of the event types; and
outputting new feature information for each of the event types using the feature information, the feature candidate information, and the belonging degree.

8. The event analysis support method according to claim 7, further comprising:
inputting the feature information into an analysis model set in advance and outputting an analysis result.

9. The event analysis support method according to claim 7,
wherein the event information includes identification information that expresses a type of the event, state information that expresses a state of the system, interval information that expresses a time interval between the event and another event, or information that is a combination of two or more of the identification information, the state information, and the interval information.

10. The event analysis support method according to claim 7,
wherein a magnitude relationship of the belonging degree and a magnitude relationship of a contribution of the feature candidate information to the new feature information match.

11. The event analysis support method according to claim 7,
wherein a number of the event types is set to be less than or equal to a number of patterns of actual events.

12. The event analysis support method according to claim 7, further comprising:
training models that output the belonging degree, the feature candidate information, and the feature information, using an event series that occurred in the system in the past.

13. A non-transitory computer-readable recording medium that includes a program recorded thereon, the program including instructions that cause a computer to carry out:
outputting a belonging degree indicating a degree to which event information pertaining to an event occurring in a system belongs to each of a plurality of event types set in advance;
outputting feature candidate information for each of the event types, using event information of an event that has newly occurred and feature information expressing a feature among events already generated for each of the event types; and
outputting new feature information for each of the event types using the feature information, the feature candidate information, and the belonging degree.

14. The non-transitory computer-readable recording medium according to claim 13, the program further including instructions that cause the computer to carry out:
inputting the feature information into an analysis model set in advance and outputting an analysis result.

15. The non-transitory computer-readable recording medium according to claim 13,
wherein the event information includes identification information that expresses a type of the event, state information that expresses a state of the system, interval information that expresses a time interval between the event and another event, or information that is a combination of two or more of the identification information, the state information, and the interval information.

16. The non-transitory computer-readable recording medium according to claim 13,
wherein a magnitude relationship of the belonging degree and a magnitude relationship of a contribution of the feature candidate information to the new feature information match.

17. The non-transitory computer-readable recording medium according to claim 13,
wherein a number of the event types is set to be less than or equal to a number of patterns of actual events.

18. The non-transitory computer-readable recording medium according to claim 13, the program further including instructions that cause the computer to carry out:
training models that output the belonging degree, the feature candidate information, and the feature information, using an event series that occurred in the system in the past.
